(19) United States
(12) Patent Application Publication
(10) Pub. No.: US 2009/0014133 A1
(43) Pub. Date: Jan. 15, 2009

(54) Multi-Section Curtain

(76) Inventor: Shih-Ming Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/775,962

(22) Filed: Jul. 11, 2007

(51) Int. Cl. E06B 3/32

(52) U.S. Cl. 160/181

(57) ABSTRACT

A multi-section curtain comprises an upper rail including a first curtain body provided therebeneath and fixed by a first offset rail, and including a second curtain body, top end of which is connected with the bottom of the first offset rail, wherein between the first offset rail and the upper rail is defined with a magnetic structure for magnetically engaging the first offset rail with the upper rail together, such that an interspace may be avoidable while reeling the curtain by a reeler.

### BACKGROUND OF THE INVENTION

1. Field of the Invention

The present invention relates to a curtain, and more particularly to a multi-section curtain that an interspace may be avoidable while reeling the curtain by a reeler thereof.

2. Description of the Prior Arts

Referring to FIG. 5, a prior art multi-section curtain comprises an upper rail 5 including a reeler provided therein, a plurality of curtain bodies including cords 8 extending downwardly for controlling the curtain bodies, wherein a first curtain body 6 includes a first offset rail 61 fixed at the bottom thereof such that the cords 8 pass through the first offset rail 61. During operating a second curtain body 7 and other curtain bodies to shade downwardly, the cords 8 will rub with the first offset rail 61 to pull the first offset rail 61 downward, causing an interspace without completely shading the sunshine. As a result, the user has to pull the first offset rail 61 upward, causing a complicated operation. Also, if the reeler operates poorly, even though retracting the entire curtain bodies, an interspace between the first offset rail 61 and the upper rail 5 still exists, causing an incomplete aesthetic appearance.

The present invention has arisen to mitigate and/or obviate the afore-described disadvantages.

### SUMMARY OF THE INVENTION

The primary object of the present invention is to provide a multi-section curtain that an interspace may be avoidable while reeling the curtain by a reeler.

The secondary object of the present invention is to provide a multi-section curtain that may obtain the stability of a first offset rail.

Another object of the present invention is to provide a multi-section curtain that enable curtain bodies to engage with each other during retracting the multi-section curtain by using a magnetic structure.

In accordance with one aspect of the present invention, there is provided a multi-section curtain comprising an upper rail including a first curtain body provided therebeneath and fixed by a first offset rail, and including a second curtain body, top end of which is connected with the bottom of the first offset rail, wherein between the first offset rail and the upper rail is defined with a magnetic structure for magnetically engaging the first offset rail with the upper rail together, such that an interspace may be avoidable while reeling the curtain by a reeler.

From above-mentioned descriptions, since the magnetic structure is defined between the first offset rail and the upper rail, and includes a magnetic block and a magnetic piece disposed therein, or includes two magnetic blocks for attracting with each other mounted therein, when the user operates the first offset rail to move toward the uppermost side and to contact with the bottom of the upper rail, the first offset rail and the upper rail may engageably connect with each other, hence during operating the second curtain body and other curtain bodies therebelow, cords relatively pass the first offset rail to cause a friction for stopping the first offset rail moving downward, thereby obtaining the stability of the first offset rail.

Besides, the second curtain body includes a second offset rail secured therebeneath for coupling with a third curtain body affixed by a third offset rail, and includes a magnetic structure having a magnetic block and a magnetic piece arranged therein or having two magnetic blocks for attracting with each other defined between the second offset rail and the third offset rail, thereby enabling the curtain bodies to engage with each other during retracting the multi-section curtain by using the magnetic structure.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the assembly of a multi-section curtain according to the present invention;

FIG. 2 is a cross sectional diagram illustrating a magnetic structure of the multi-section curtain according to the present invention;

FIG. 3 is a perspective diagram illustrating the operational state of the multi-section curtain according to the present invention;

FIG. 4 is another perspective diagram illustrating the assembly of the multi-section curtain according to the present invention;

FIG. 5 is a perspective diagram illustrating the assembly of a prior art multi-section curtain.

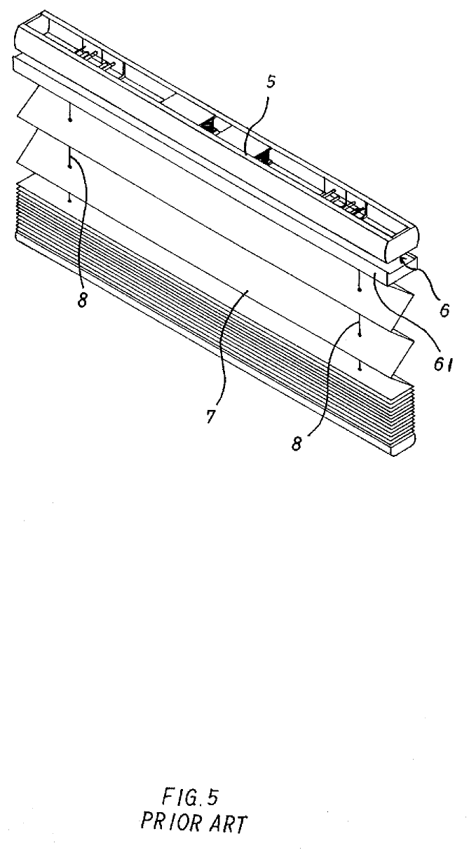

### DETAILED DESCRIPTION OF THE PREFERRED EMBODIMENT

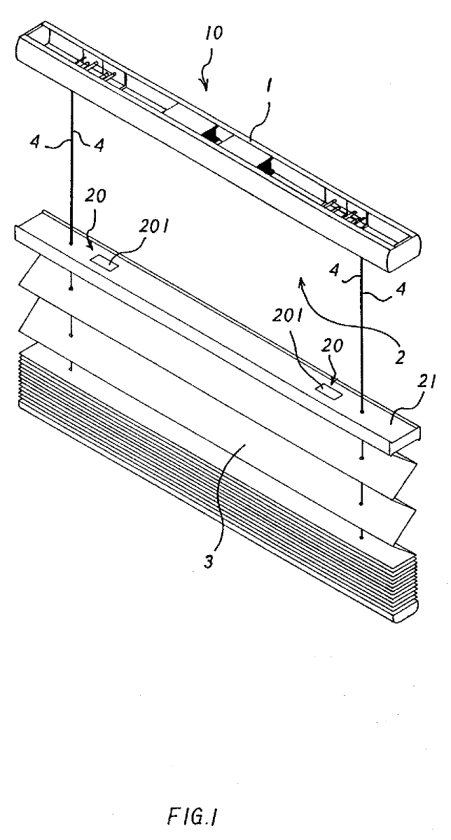

A multi-section curtain 10 in accordance with the present invention comprises an upper rail 1 including a first curtain body 2 provided therebeneath and fixed by a first offset rail 21, as show in FIG. 1, and including a second curtain body 3, top end of which is connected with the bottom of the first offset rail 21, wherein between the first offset rail 21 and the upper rail 1 is defined with a magnetic structure 20 for magnetically engaging the first offset rail 21 with the upper rail 1 together, such that an interspace may be avoidable while reeling the curtain by a reeler.

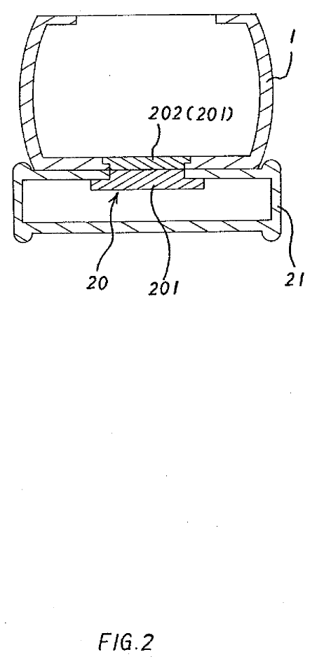

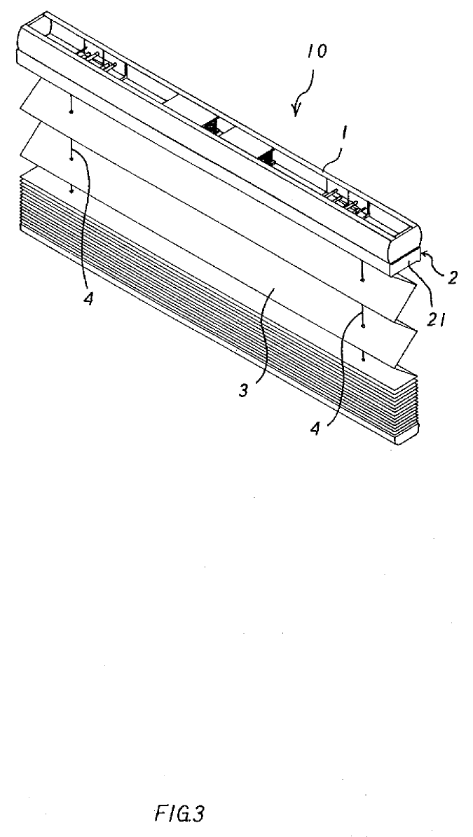

From above-mentioned descriptions, since the magnetic structure 20 is defined between the first offset rail 21 and the upper rail 1 as illustrated in FIG. 2, and includes a magnetic block 201 and a magnetic piece 202 disposed therein, or includes two magnetic blocks 201 for attracting with each other mounted therein, when the user operates the first offset rail 21 to move toward the uppermost side and to contact with the bottom of the upper rail 1, the first offset rail 21 and the upper rail 1 may engageably connect with each other, as shown in FIG. 3, hence during operating the second curtain body 3 and other curtain bodies therebelow, cords 4 relatively pass the first offset rail 21 to cause a friction for stopping the first offset rail 21 moving downward, thereby obtaining the stability of the first offset rail 21.

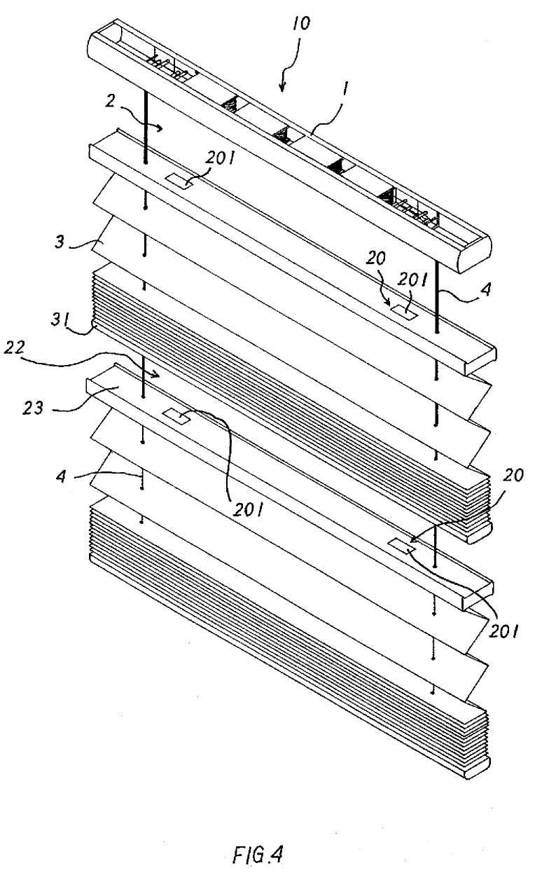

Besides, the second curtain body 3 includes a second offset rail 31 secured therebeneath for coupling with a third curtain body 22 affixed by a third offset rail 23, as illustrated in FIG. 4, and includes a magnetic structure 20 having a magnetic block 201 and a magnetic piece 202 arranged therein or having two magnetic blocks 201 for attracting with each other defined between the second offset rail 31 and the third offset ail 23, thereby enabling the curtain bodies to engage with each other during retracting the multi-section curtain 10 by using the magnetic structure 20.

The invention is not limited to the above embodiment but various modifications thereof may be made. It will be understood by those skilled in the art that various changes in form and detail may made without departing from the scope and spirit of the present invention.

What is claimed is:

1. A multi-section curtain comprising:
an upper rail including a first curtain body provided therebeneath and fixed by a first offset rail, and including a second curtain body, top end of which is connected with the bottom of said first offset rail, wherein between said first offset rail and said upper rail is defined with a magnetic structure for magnetically engaging said first offset rail with said upper rail together, such that an interspace may be avoidable while reeling said curtain by a reeler.

2. The multi-section curtain as claimed in claim 1, wherein said magnetic structure includes a magnetic block and a magnetic piece disposed therein.

3. The multi-section curtain as claimed in claim 1, wherein said magnetic structure includes two magnetic blocks for attracting with each other mounted therein.

4. The multi-section curtain as claimed in claim 1, wherein said second curtain body includes a second offset rail secured therebeneath for coupling with a third curtain body affixed by a third offset rail, and includes a magnetic structure having a magnetic block and a magnetic piece arranged therein or having two magnetic blocks for attracting with each other defined between said second offset rail and said third offset rail.
